(19) United States
(12) Patent Application Publication
(10) Pub. No.: US 2013/0200664 A1
(43) Pub. Date: Aug. 8, 2013

(54) VEHICLE SEAT SIDE AIR BAG ASSEMLBY HAVING STRAP SECURED AIR BAG CHUTE

(71) Applicants: Louella Ann Patterson, Goodells, MI (US); Bryan L. Orlando, Sterling Heights, MI (US); William J. Paruszkiewicz, JR., Clinton Twp., MI (US); James B. Clauser, Oakland Twp., MI (US); Thomas A. Welch, SR., Ortonville, MI (US); Paul S. Severinski, Brownstown, MI (US)

(72) Inventors: Louella Ann Patterson, Goodells, MI (US); Bryan L. Orlando, Sterling Heights, MI (US); William J. Paruszkiewicz, JR., Clinton Twp., MI (US); James B. Clauser, Oakland Twp., MI (US); Thomas A. Welch, SR., Ortonville, MI (US); Paul S. Severinski, Brownstown, MI (US)

(73) Assignee: LEAR CORPORATION, Southfield, MI (US)

(21) Appl. No.: 13/367,660

(22) Filed: Feb. 7, 2012

(51) Int. Cl. B60N 2/42; B60R 21/23

(52) U.S. Cl. 297/216.1

(57) ABSTRACT

A vehicle seat air bag assembly (17) having an air bag module (18) includes an air bag chute (44) that is foldable from a flexible sheet (46). The air bag chute (44) guides an air bag (40) of the air bag module (18) during inflation and movement to and through a trim cover deployment seam (34). The flexible sheet (46) has a panel (52) that is folded to provide panel portions (56) and (58) and straps (62) of one panel portion (56) extend therefrom in opposite directions and are folded back to connections (66) with the other panel portion (58). The connections (66) may be provided by stitching (70), heat staking (82), sonic welding (84) or slits (86) in the other panel portion for receiving the straps.

### TECHNICAL FIELD

This invention relates to a vehicle seat side air bag assembly having an air bag chute for guiding an air bag upon deployment and having a folded construction secured by straps.

### BACKGROUND

Vehicle seat components have previously included side air bag modules and conventionally include trim covers that have an air bag deployment seam to which an air bag upon inflation moves through a chute and through which deployment seam the air bag is projected outwardly from within the seat to provide occupant protection. See, for example, the U.S. Pat. No. 7,637,531 of William J. Paruszkiewicz et al.

Other prior art references noted during an investigation conducted for this invention include United States patents: U.S. Pat. No. 5,498,030 Hill et al.; U.S. Pat. No. 5,678,853 Maly; 5,749,597 Saderholm; U.S. Pat. No. 5,810,389 Yamaji et al.; U.S. Pat. No. 5,816,610 Higashiura et al.; U.S. Pat. No. 5,860,673 Hasegawa et al.; U.S. Pat. No. 5,890,734 Saderholm; U.S. Pat. No. 5,927,749 Homier et al.; U.S. Pat. No. 5,938,232 Kalandek et al.; U.S. Pat. No. 5,967,546 Homier et al.; U.S. Pat. No. 5,967,603 Genders et al.; U.S. Pat. No. 5,992,878 Narita et al.; U.S. Pat. No. 5,997,032 Miwa et al.; U.S. Pat. No. 6,045,151 Wu; U.S. Pat. No. 6,206,410 Brown; U.S. Pat. No. 6,237,934 Harrell et al.; U.S. Pat. No. 6,254,122 Wu et al.; U.S. Pat. No. 6,352,304 Sorgenfrei; U.S. Pat. No. 6,467,801 Preisler et al.; and U.S. Pat. No. 6,588,838 Dick, Jr. et al; and also see PCT publication WO 00/09365 A1.

### SUMMARY

An object of the present invention is to provide an improved vehicle seat side air bag assembly for providing seat occupant protection.

In carrying out the above object, a vehicle seat side air bag assembly constructed in accordance with the invention includes a vehicle seat having a frame, a foam pad mounted on the frame, and a trim cover that covers the foam pad and has an air bag deployment seam. An air bag module of the air bag assembly is mounted on the frame and has an inflator and an air bag that is inflated by the inflator to open the deployment seam of the trim cover and extend outwardly therethrough to provide vehicle seat occupant protection. An air bag chute of the air bag assembly is fabricated from a flexible sheet and has an inner extremity that receives the air bag module and an outer extremity located toward the deployment seam of the trim cover so the air bag upon inflation moves to and through the deployment seam of the trim cover. The flexible sheet has a panel including a folded junction at the inner extremity of the air bag chute to provide a pair of panel portions. One of the panel portions at the outer extremity of the air bag chute includes a pair of straps that extend from the one panel portion in opposite directions as each other and are folded back to the other panel portion, and connections of the air bag chute secure the straps to the other panel portion.

The vehicle seat side air bag assembly as disclosed has the flexible sheet made from a synthetic resin.

The vehicle seat side air bag assembly as disclosed has the air bag module including threaded studs that mount the air bag module on the frame of the seat. As disclosed, the panel has stud holes that receive the threaded studs, and the straps of the one panel portion and the other panel portion have alignment holes that are aligned upon folding of the straps to provide proper positioning of the straps upon connection to the other panel portion.

One embodiment includes stitching that provides the connections of the straps to the other panel portion. The stitching as disclosed includes an elongated stitch having opposite ends providing the connections that secure the straps to the other panel portion, and the elongated stitch has an intermediate portion that extends between its opposite ends and passes through only the other panel portion at the outer extremity of the air bag chute.

Another embodiment has the connections heat staked and a further embodiment has the connections sonic welded.

The connections are also disclosed in a further embodiment as including slits in the other panel portion that receive the straps. The slits are slanted with respect to the fold line, and the straps have curved shapes extending from the one panel portion so as to be received within the slanted slits in the other panel portion.

The vehicle seat air bag assembly as disclosed is mounted within a vehicle seat back of a vehicle seat on a frame of the vehicle seat back.

The objects, features and advantages of the present invention are readily apparent from the following detailed description of the preferred embodiments when taken in connection with the accompanying drawings.

### BRIEF DESCRIPTION OF THE DRAWINGS

FIG. 1 is a perspective view of a vehicle seat side air bag assembly including a seat back component constructed in accordance with the invention to include a side air bag module that is shown by hidden line illustration.

FIG. 2 is a side elevational view of the vehicle seat back component taken along the direction of line 2-2 in FIG. 1 with the side air bag module thereof also illustrated by hidden line representation.

FIG. 3 is a partial sectional view taken along the direction of line 3-3 in FIG. 2 to illustrate the manner in which the air bag module is mounted within the seat.

FIG. 4 is a view illustrating a flexible sheet that is folded and connected to provide an air bag chute that receives the air bag module and guides an air bag thereof upon inflation toward a deployment seam of a trim cover of the seat.

FIG. 5 is perspective view illustrating the air bag chute after folding and connection of portions thereof to provide the air bag chute.

FIG. 6 is a perspective view illustrating the air bag chute with the air bag module received therein and ready for assembly within the seat back component.

FIG. 7 is a partial sectional view illustrating the manner in which the connections can be provided by heat staking of the straps to the other panel portion.

FIG. 8 is a sectional view of a further embodiment illustrating the connections of the straps to the other panel portion as being provided by sonic welding.

FIG. 9 is a view similar to FIG. 4 of a further embodiment which includes slits and straps that are received by the slits after folding to secure the panel portions to each other.

FIG. 10 illustrates the completed assembly of the FIG. 9 embodiment.

### DETAILED DESCRIPTION

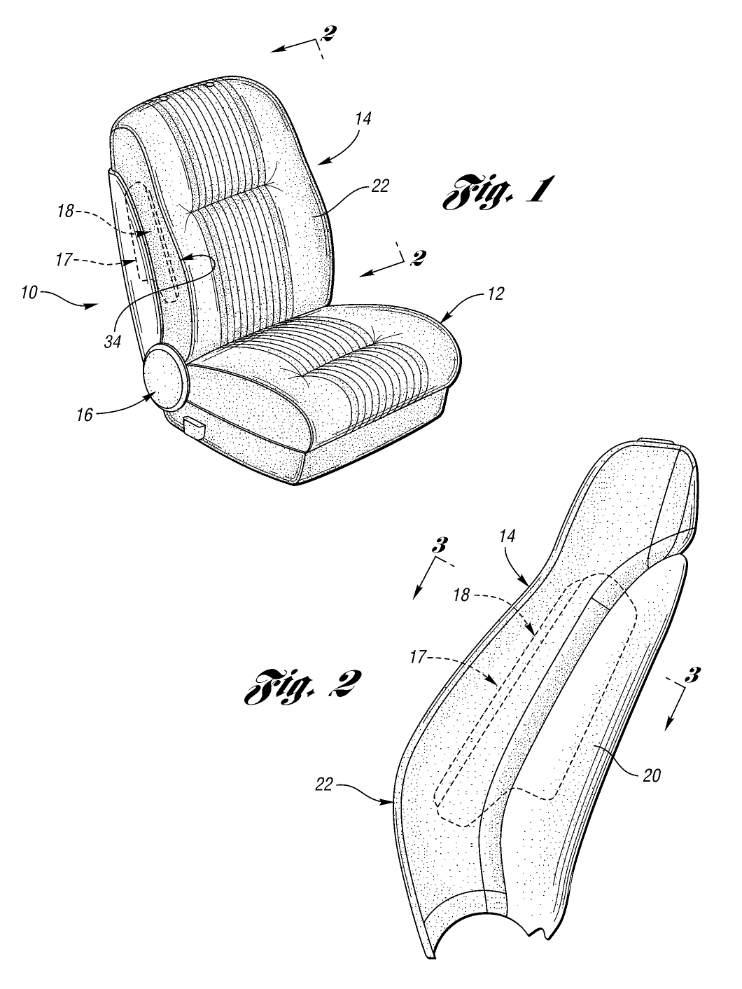

With reference to FIG. 1 of the drawings, a vehicle seat generally indicated by 10 includes a seat bottom 12 for mounting on a vehicle floor and a seat back 14 mounted in a generally upstanding manner on the seat bottom with its angular position controlled in a conventional manner by a recliner generally indicated by 16. The seat back component 14 includes a side air bag assembly 17 that is constructed in accordance with the present invention and includes a side air bag module 18 operable to provide seat occupant protection as is hereinafter more fully described. While the side air bag module 18 is shown on the seat back 14, which is a usage for which it has particular utility, it is also possible for the side air bag module to be utilized with a seat bottom 12 even though the seat back usage is specifically disclosed. Also, as illustrated, the side air bag module 18 is located at an outboard lateral side or extremity of the seat to provide protection against adjacent vehicle structure, but it is also possible to have the side air bag module located at the inboard lateral side to provide protection against an adjacent vehicle occupant and to also have side air bag modules at both outboard and inboard locations for protection in both lateral directions. As shown in FIG. 2, the seat back 14 includes a back panel 20 that is conventionally molded from plastic and also includes a front cushion 22 against which the seat occupant leans to provide back support and in which the side air bag module 18 is located.

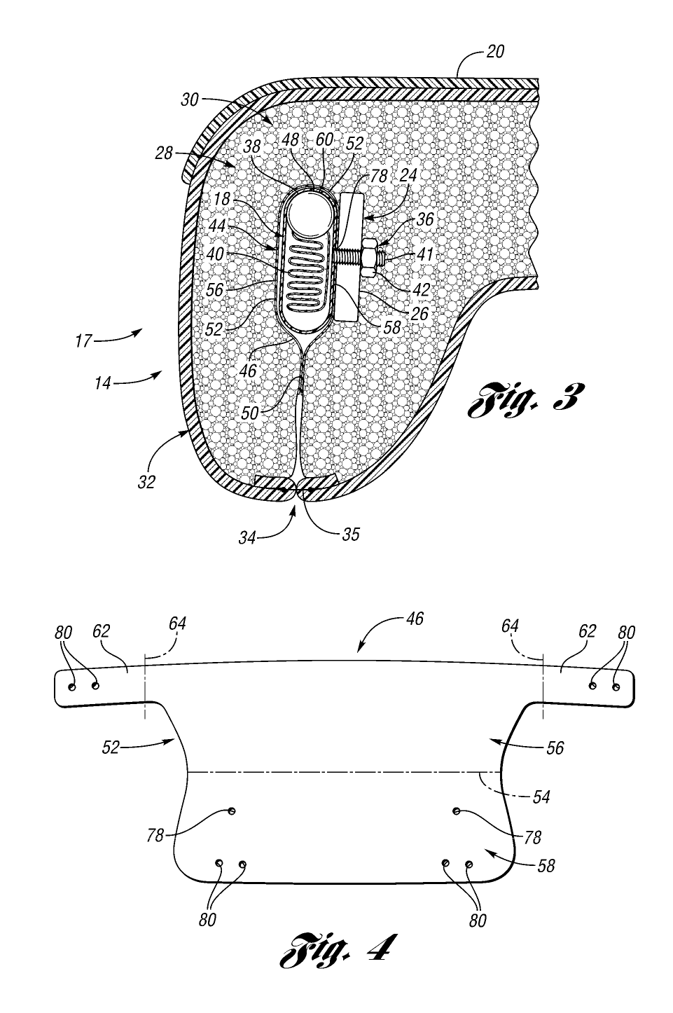

As illustrated in FIG. 3, the seat back component 14 includes a frame collectively identified by 24 and having a pair of frame members 26 (only one shown) at its opposite lateral sides. A foam pad 28 is mounted on the frame 24 in any conventional manner and has opposite side extremities 30 (only one shown) spaced laterally from each other at the opposite lateral sides of the seat. A trim cover generally indicated by 32 extends over the foam pad 28 and includes an air bag deployment seam or release seam 34 adjacent the shown side extremity 30 of the foam pad which corresponds to an outboard location. The deployment seam 34 includes stitching 35 of trim cover portions to each other.

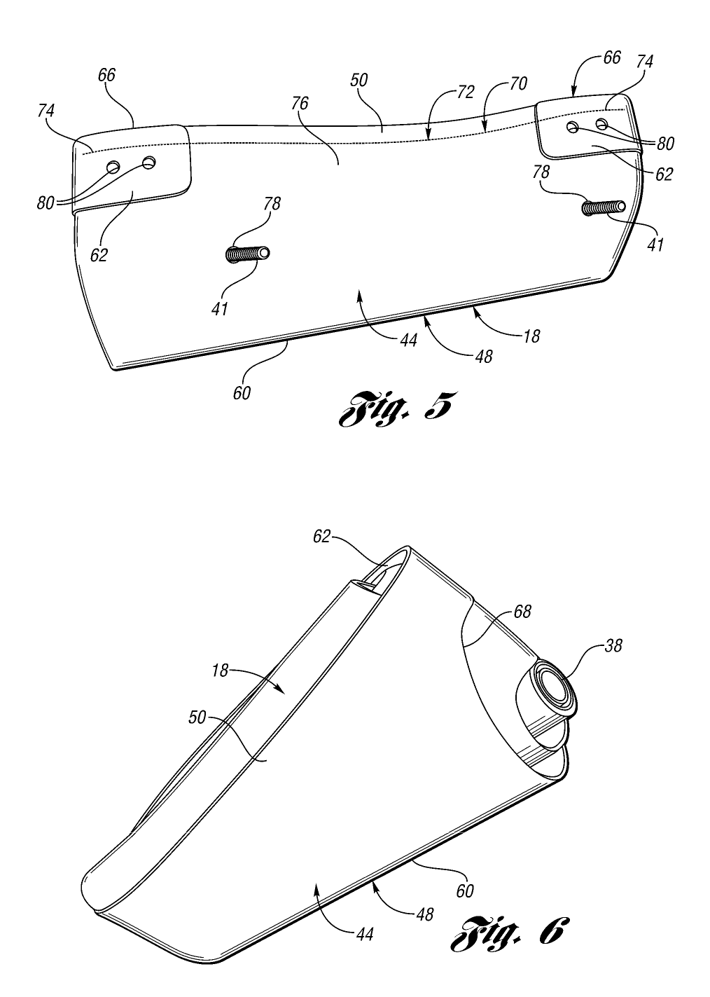

The side air bag module 18 is located within the trim cover 32 mounted on the frame 24, specifically by a threaded connection 36 on the one side frame member 26 adjacent the air bag release seam 34 but in an inwardly spaced relationship from the release seam. The air bag module 18 includes an inflator 38 and a schematically illustrated air bag 40 which may be folded or rolled. Upon deployment, the air bag 40 is inflated by the inflator 38 and projected outwardly from the seat component through the air bag deployment seam 34 of the trim cover 32 which may be made of cloth, vinyl or leather, etc. The threaded connection 36 includes a pair of threaded studs 41 (shown in FIG. 6) each of which extends through the frame 24 as shown in FIG. 3 and receives an associated nut 42 on the opposite side of the frame to provide the mounting of the air bag module 18.

As shown in FIG. 3, the side air bag assembly 17 includes an air bag chute 44 that is fabricated from a flexible sheet 46 as is hereinafter more fully described. More specifically, the air bag chute 44 after completion of its fabrication has an inner extremity 48 that receives the air bag module 18 and has an outer extremity 50 located toward the deployment seam 34 of the trim cover 32 so the air bag 40 upon inflation moves to and through the deployment seam of the trim cover in order to provide occupant protection.

The flexible sheet 46 shown in FIG. 4 is made from a synthetic resin such as a thermoplastic polyolefin. This flexible sheet 46 includes a panel 52 of a somewhat rectangular shape that is folded along a phantom indicated fold line 54 to provide a pair of panel portions 56 and 58 that have a folded junction 60 at the inner extremity 48 of the air bag chute 44 as shown in FIG. 3. The one panel portion 56 includes a pair of straps 62 that have elongated shapes and extend from the one panel portion in opposite directions as each other. The straps 62 are folded back to the other panel portion 58 about associated fold lines 64 after the folding of panel 52 to provide the inner and outer extremities of the air bag chute. As shown in FIG. 5, connections 66 of the air bag chute secure the straps 62 of the one panel portion 56 to the other panel portion 58 adjacent its outer extremity 50. The strap secured connections 66 permit the air bag chute to have an opening 68 at one or both ends of its elongated shape in order to permit control wiring to extend from the air bag module 18 to control circuitry.

The air bag module as shown in FIG. 5 has stitching 70 that embodies the connections 66 of the straps 62 of the one panel portion 56 to the other panel portion 58. More specifically, this stitching 70 includes an elongated stitch 72 having opposite ends 74 providing the connections 66 that secure the straps 62 to the panel portion 58, and the stitch 72 also has an intermediate portion 76 that extends between its opposite ends 74 and passes through only the other panel portion 58 at the outer extremity of the air bag chute. The single stitch 72 facilitates the fabrication of the air bag chute in providing the connections 66 since only one pass through a stitching machine is then necessary which accounts for the stitching at the intermediate portion where no securement is provided. The panel 52 has stud holes 78 through which the threaded studs 41 extend from the air bag module as show in FIG. 5 for the threaded securement as previously described in connection with FIG. 3.

As shown in FIG. 4 the straps 62 and the other panel portion 58 have alignment holes 80 that are aligned upon the folding so as to ensure that the straps are properly positioned upon connection.

FIG. 7 illustrates an embodiment in which the connections 66 of the straps 62 to the other panel portion 58 are provided by a heat stake 82.

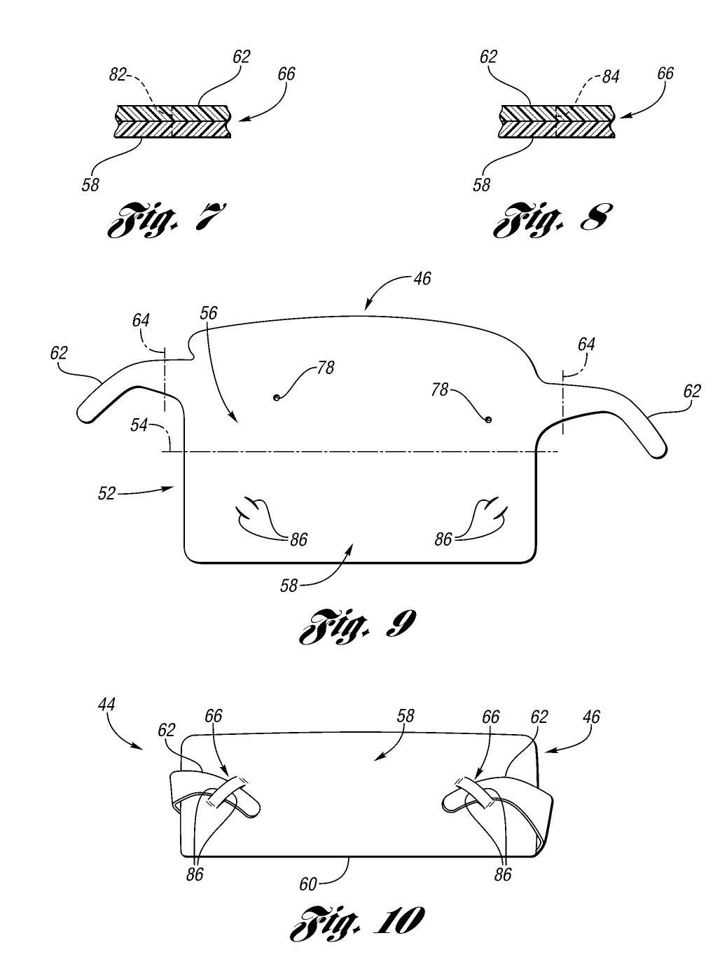

FIG. 8 is a sectional view illustrating another embodiment in which the connections 66 of the straps 62 to the other panel portion 58 are provided by sonic welds 84.

FIGS. 9 and 10 respectively illustrate another embodiment of the flexible sheet 46 in unfolded and folded assembled conditions. In this embodiment, the other panel 58 includes slits 86 that receive the straps 62 to provide the connections 66 that maintain the folded condition of the air bag chute 44. More specifically, the slits 86 are slanted with respect to the fold line 54 and the straps 62 have curved shapes that extend through the slits to secure the folded construction of the air bag chute 44. Each strap 62 as disclosed is associated with a pair of the slits 86 extending therethrough so as to contact the inner surface of the other panel 58 between the associated slits and the outer surface of the other panel 58 on the opposite sides of the slit in a manner than secures the connection.

It should be appreciated that the air bag module 18 and air bag chute 44 can be used with other seat constructions than the seat structure shown, such as for example as in the previously mentioned U.S. Pat. No. 7,637,531 Paruszkiewicz et al. and the other previously mentioned patents, the entire disclosures of which are hereby incorporated by reference.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the invention.

What is claimed is:

1. A vehicle seat side air bag assembly comprising:
a vehicle seat having a frame, a foam pad mounted on the frame, and a trim cover that covers the foam pad and has an air bag deployment seam;
an air bag module mounted on the frame and having an inflator and an air bag that is inflated by the inflator to open the deployment seam of the trim cover and extend outwardly therethrough to provide vehicle seat occupant protection; and
an air bag chute that is fabricated from a flexible sheet and has an inner extremity that receives the air bag module and an outer extremity located toward the deployment seam of the trim cover so the air bag upon inflation moves to and through the deployment seam of the trim cover, the flexible sheet including a panel that has a folded junction at the inner extremity of the air bag chute to provide a pair of panel portions, one of the panel portions at the outer extremity of the air bag chute including a pair of straps that extend from the one panel portion in opposite directions as each other and are folded back to the other panel portion, and connections that secure the straps to the other panel portion.

2. A vehicle seat side air bag assembly as in claim 1 wherein the flexible sheet is made from a synthetic resin.

3. A vehicle seat side air bag assembly as in claim 1 wherein the air bag module includes threaded studs that mount the air bag module on the frame of the seat.

4. A vehicle seat side air bag assembly as in claim 3 wherein the panel has stud holes that receive the threaded studs.

5. A vehicle seat side air bag assembly as in claim 3 wherein the straps of the one panel portion and the other panel portion have alignment holes that are aligned upon folding of the straps to provide proper locations of the connections.

6. A vehicle seat side air bag assembly as in claim 3 wherein the panel has stud holes that receive the threaded studs, and the straps of the one panel portion and the other panel portion having alignment holes that are aligned upon folding of the straps to provide proper positioning of the straps upon connection to the other panel portion.

7. A vehicle seat side air bag assembly as in claim 1 which includes stitching that embodies the connections of the straps to the other panel portion.

8. A vehicle seat side air bag assembly as in claim 3 wherein the stitching includes an elongated stitch having opposite ends providing the connections that secure the straps to the other panel portion, and the elongated stitch having an intermediate portion that extends between its opposite ends and passes through only the other panel portion at the outer extremity of the air bag chute.

9. A vehicle seat side air bag assembly as in claim 1 wherein the connections are heat staked.

10. A vehicle seat side air bag assembly as in claim 1 wherein the connections are sonic welded.

11. A vehicle seat side air bag assembly as in claim 1 wherein the connections include slits in the other panel portion that receive the straps.

12. A vehicle seat side air bag assembly as in claim 11 wherein the slits are slanted with respect to the fold line, and the straps having curved shapes extending from the one panel portion so as to be received within the slanted slits in the other panel portion.

13. A vehicle seat side air bag assembly comprising:
a vehicle seat having a frame, a foam pad mounted on the frame, and a trim cover that covers the foam pad and has an air bag deployment seam;
an air bag module including threaded studs providing mounting thereof on the frame, and the air bag module having an inflator and an air bag that is inflated by the inflator to open the deployment seam of the trim cover and extend outwardly therethrough to provide vehicle seat occupant protection; and
an airbag chute that is fabricated from a flexible sheet of synthetic resin and has an inner extremity that receives the air bag module and an outer extremity located toward the deployment seam of the trim cover so the air bag upon inflation moves to and through the deployment seam of the trim cover, the flexible sheet including a panel that has a folded junction at the inner extremity of the air bag chute to provide a pair of panel portions, one of the panel portions at the outer extremity of the air bag chute including a pair of straps that extend from the one panel portion in opposite directions as each other and are folded back to the other panel portion, and the other panel including slits that receive the straps to provide connections that secure the panel portions to each other.

14. A vehicle seat side air bag assembly comprising:
a vehicle seat including a seat back having a frame, a foam pad mounted on the frame, and a trim cover that covers the foam pad and has an air bag deployment seam;
an air bag module including threaded studs providing mounting thereof on the frame, and the air bag module having an inflator and an air bag that is inflated by the inflator to open the deployment seam of the trim cover and extend outwardly therethrough to provide vehicle seat occupant protection;
an airbag chute that is fabricated from a synthetic resin flexible sheet and has an inner extremity that receives the air bag module and an outer extremity located toward the deployment seam of the trim cover so the air bag upon inflation moves to and through the deployment seam of the trim cover, the flexible sheet including a panel that has a folded junction at the inner extremity of the air bag chute to provide a pair of panel portions, and one of the panel portions including a pair of curved straps that extend from the one panel portion in opposite directions as each other and are folded back to the other panel portion;
the other panel having slits that are slanted with respect to the fold line and receive the curved straps to provide connections that secure the panel portions to each other; and
the panel having stud holes that receive the threaded studs.
